(19) United States
(12) Patent Application Publication
(10) Pub. No.: US 2014/0260522 A1
(43) Pub. Date: Sep. 18, 2014

(54) HOME POSITION INDICATOR, ENCODER POSITION MEASUREMENT SYSTEM INCLUDING A HOME POSITION INDICATOR, AND A METHOD OF DETECTING A HOME POSITION

(71) Applicant: The Raymond Corporation, (US)

(72) Inventor: Richard M. Day, Port Crane, NY (US)

(73) Assignee: The Raymond Corporation, Greene, NY (US)

(21) Appl. No.: 13/828,762

(22) Filed: Mar. 14, 2013

(51) Int. Cl. G01B 21/00

(52) U.S. Cl. CPC G01B 21/00
USPC 73/1.79

(57) ABSTRACT

A home position indicator that enhances the functionality of an incremental encoder with characteristics of an absolute encoder includes a target flag having a plurality of marks. In one embodiment, pairs of adjacent marks of the plurality of marks define sections between each adjacent pair of marks of the plurality of marks. Each section has a width, wherein one of the sections has a width greater than a width of another of the sections. A sensor sequentially senses two adjacent marks of said plurality of marks to determine a width of the section defined between the two adjacent marks.

### CROSS REFERENCES TO RELATED APPLICATIONS

Not Applicable

### STATEMENT REGARDING FEDERALLY SPONSORED RESEARCH

Not Applicable.

### BACKGROUND OF THE INVENTION

The present invention relates to encoders, and more particularly to methods and assemblies for determining a home position on an incremental encoder.

In many industrial control applications it is beneficial for the machine control system to know the position of some components of a work machine, such as the height of the lift mechanism (linear position) or the position of a rotating component of a steering application (rotary position). Ideally an absolute measurement device would be used so that the position of the machine was known as soon as power was applied to the control system. Unfortunately these devices are complex and difficult to apply.

An alternative is to use an incremental encoder 1, such as shown in FIG. 1 which measures relative movement of the work machine component along with a sensor 2 and target flag 3 mounted on the work machine to detect when the component is in a known “home” position. The incremental encoder 1 can then be used to track the movements of the work machine. The sensor 2 is typically an on/off type proximity switch capable of detecting metal, and this switch is typically used in conjunction with the target flag 3 made of a material compatible with the switch, usually steel. The target flag 3 is then moved by the work machine component in proximity to the switch 2, and the home position becomes a singular point where the switch detects the transition from sensing metal to not sensing metal, and/or from not sensing metal to sensing metal.

One known target flag 3 for a rotary application as shown in FIG. 1 consists of a metal disk which has a section cut out 4 or notched, which is then affixed to the rotating component 5 of the work machine. The sensor 2 is then mounted perpendicular to the target flag 3, such that it can sense the presence or absence of the metal as the target flag 3 and work machine component rotate. The unique point where the target flag 3 transitions from presence of metal to absence of metal (and/or vice versa) indicates the “Home” position, which typically is at or near the straight ahead position of a steering mechanism.

This standard type of target flag is often referred to as a “half-moon” type flag system since one half still has the metal present and the other half has had it removed. In operation the work machine will read the state of the proximity switch at power up, and then move the work machine component until the home position is found. From there the incremental encoder is used to track movements of the work machine. The target flag can also be reduced in size to little more than 90 degrees of a full circle in order to facilitate installation and service of the component. The extra size beyond 90 degrees is useful in accommodating any over-travel of the mechanism and/or component tolerances.

Many work machines are designed to initiate this homing procedure automatically after reaching an operational status. In this case the initial state of the home switch provides the information needed to determine which way to move the work machine in order to reach the home position. If the home switch is not functional, the work machine may move in the wrong direction and/or move well past the intended home position. A manual homing procedure can also be effectively used in many other applications such as steering, especially when the need for the absolute position is not a critical factor in the operation of the work machine.

With the half-moon type of target flag of FIG. 1, the work machine may start up at one of the extreme positions, and then it will have to move 90 degrees in order to find the home position. This can take several seconds to accomplish since homing speeds are typically limited and this can also cause significant wear of the work machine. In the case of a steering system, the work machine tire is typically rotated with the vehicle stopped causing a great deal of tire scrubbing and wear. Turning the steering while the work machine is stationary also requires maximum torque causing maximum stress to the components of the steering system. This same design can be extended to permit larger angles of movement, but the maximum movement must be limited to less than 360 degrees or else two home positions will be created and the home position will not be unique. Increasing the angle of movement will also increase the maximum possible amount of movement needed to find the absolute position.

Incremental quadrature encoders can require excessive movement of the work machine component to get to the a “home” position. This extensive movement can be very undesirable in terms of lost productivity, in terms of machine wear, and in terms of operator inconvenience. Therefore, a need exists for a method and assembly for quickly determining a home position on an incremental encoder.

### SUMMARY OF THE INVENTION

The present invention provides a home position indicator that enhances the functionality of an incremental encoder with characteristics of an absolute encoder without the complexity of an absolute encoder. In one embodiment of the invention, a home position indicator includes a target flag having a plurality of marks. Pairs of adjacent marks of the plurality of marks define sections between each adjacent pair of marks of the plurality of marks. Each section has a width, wherein one of the sections has a width greater than a width of another of the sections. A sensor sequentially senses two adjacent marks of said plurality of marks to determine a width of the section defined between the two adjacent marks.

In another aspect, the present invention provides a method of detecting a home position. The method includes detecting a first mark defining a first edge of a section on a target flag having a plurality of marks defining a plurality of sections, detecting a second mark defining a second edge of the section, calculating a width of the section based upon a position of the first edge relative to the second edge; and comparing the width to a list of widths. Each of the widths in the list of widths corresponding to at least one section of the plurality of sections, wherein at least one of the widths of the list of widths being greater than another of the widths of the list of widths.

In yet another aspect, the present invention provides an encoder position measurement system including a home position indicator and an incremental encoder. The home position indicator has a plurality of home positions defined by a plurality of marks. The incremental encoder measures a relative position of the marks to determine an absolute position of one of the home positions.

These and still other aspects of the present invention will be apparent from the description that follows. In the detailed description, a preferred example embodiment of the invention will be described with reference to the accompanying drawings. This embodiment does not represent the full scope of the invention; rather the invention may be employed in other embodiments. Reference should therefore be made to the claims herein for interpreting the breadth of the invention.

### BRIEF DESCRIPTION OF THE DRAWINGS

FIG. 1 is a top, side perspective view of a prior art encoder position measurement system;

FIG. 2 is a top, side perspective view of an encoder position measurement system incorporating the present invention;

FIG. 3 is a plan view of the target flag of FIG. 2;

FIG. 4 is a plan view the target flag of FIG. 3 illustrating calculation of an absolute position; and

FIG. 5 is a plan view the target flag of FIG. 3 illustrating required movement of the target flag before determining absolute position.

### DETAILED DESCRIPTION OF THE PREFERRED EXAMPLE EMBODIMENT

The preferred example embodiment will be described in relation to a rotating incremental shaft encoder. However, the present invention is equally applicable to non-rotating, such as linear, incremental encoders.

As shown in FIG. 2, an encoder position measurement system 10 incorporating the present invention includes an incremental encoder 12 and a home position indicator 14. The incremental encoder 12 is fixed to a rotating component 16 of a work machine and measures relative positions of marks. Preferably, the encoder 12 is an incremental quadrature encoder that generates signals, representing incremental encoder counts, received by a work machine control system indicating rotation of the rotating component 16 of the work machine. Each signal generated by the encoder 12 indicates that the rotating component 16 has rotated a predetermined number or fraction of a degree.

The home position indicator 14 includes a target flag 18 fixed to the rotating component 16 of the work machine, such that the target flag 18 rotates with the rotating component 16. As shown in FIG. 3, the target flag 18 includes a plurality of marks 24 indicating a plurality of home positions. In the embodiment disclosed herein, the target flag 18 is cut into several alternating sections 26a-26i (referred to collectively as 26) where material, such as metal, paper, and plastic, is either present (a flag 28) or removed (a notch 32). Each mark 24 is formed by a transition between a flag 28, i.e. material presence, and a notch 32, i.e. material absence. Although marks 24 formed by flags 28 and notches 32 are disclosed, the marks 24 can be any indicator capable of being detected by a sensor, for example the mark can be a reflective or non-reflective material applied to a target flag where the mark is the material itself or material edge without departing from the scope of the material.

The sections 26 include the two end sections 26a, 26i with intermediate sections 26b-h between the two end sections 26a, 26i. Preferably, each one of the sections 26 is unique in terms of its width in degrees with the exception of the two end sections 26a and 26i in this example. No other two flags 28 are the same width, no other two notches 32 are the same width, and no other flags 28 have the same width as any of the notches 32. Preferably, the total width of all sections 26 equals the total movement range of the rotating component 16 of the work machine.

Although providing all unique sections 26 is preferred, in certain applications, the end sections 26a, 26i of the target flag 18 can have the same width. Having the end sections 26a, 26i be unique widths is not required when one side of each end segment 26a, 26i is bounded by a physical stop making full measurement of the end section 26a, 26i width difficult. However, in applications where this is not the case the two end sections 26a, 26l can be different widths.

A sensor 42 shown in FIG. 2, such as a proximity sensor, senses each mark 24 as the rotating component 16 rotates. Upon sensing a mark 24, the sensor 42 sends a signal to the work machine control system indicating a mark 24 has been sensed. Although a proximity sensor is disclosed, the sensor 42 can be any sensor capable of sensing a mark without departing from the scope of the invention.

In normal operation the work machine control system monitors both the signals from the incremental encoder 12 along with the state of the home position indicator 14. Each time a mark 24 is sensed by the sensor 42, the control system notes the position of the rotating component 16 indicated by the incremental encoder 12. Preferably the home position indicator 14 is monitored using an interrupt to a microprocessor forming part of the work machine control system in order to capture the incremental encoder 12 counts quickly, but a high polling sample rate relative to the rotating component 16 movement rate may be sufficient. If the latest position information, i.e. the position of the rotating component 16 indicated by the incremental encoder 12 when the last mark 24 was detected by the sensor 42, is compared to the position noted at the previously detected mark 24, the width of the previous section 26 can be determined in terms of encoder counts and then in terms of degrees of rotation. From there the control system can calculate the absolute position of the rotating component based on the width of the section 26, i.e. the relative position of the two detected marks, just measured using a look-up table of section 26 widths along with information on which direction the rotating component 16 was moving. As an alternative to using a hard coded look-up table of segment widths, it is possible to have the control system perform a service mode based learn procedure where it actually measures the section 16 widths and stores those into non-volatile memory for use during normal operation.

To further illustrate how an absolute position is determined using the encoder position measurement system 10 described above, is an example shown in FIG. 4 with respect to a rotary steering application having a range of motion from +90 degrees to −90 degrees, is discussed below. In particular, if the position of a rotating component of the steering application starts at Point A in segment 26b having a width of 26 degrees, and then the target flag 18 rotates clockwise such that the position of the rotating component moves counter-clockwise through adjacent segment 26c having a width of 18 degrees, The adjacent segment 26c can be identified by the segment width of 18 degrees, and then the absolute position at the transition from segment 26c to segment 26d, knowing end segment 26a has a width of 12 degrees, is given by: (+90 degrees−12 degrees−26 degrees−18 degrees=+34 degrees). If the target flag 18 were rotating counter-clockwise the position calculation would be: (+90 degrees−12 degrees−26 degrees=+52 degrees).

Advantageously, the same type of calculations can be done for any segment 26 and at any mark 24 providing multiple “Home” positions instead of just one as in the prior art. As such the encoder position measurement system 10 acts as an absolute encoder where the resolution is a function of the size of the sections 26. The number of sections 26 can be increased greatly from the example provided above, but ultimately the resolution is limited by the target flag and the resolution of the incremental encoder. Alternatively, if the latest position information turns out to be the same as the previous position information, then the transitions are at the same rotational position and the information should be ignored.

Unlike in the prior art design of FIG. 1, the rotating component 16 does not have to move in any particular direction to get to a home position as part of an automated homing procedure. The homing procedure of the encoder position measurement system 10 can move in any arbitrary manner in an attempt to marks 24 defining find a section 26 or it must keep track of its last known position for use in the homing procedure. If arbitrary movement is done then the control system will either recognize a section 26 indicating a home position or it will cause the rotating component 16 to hit the physical stops. The physical stop itself can then become a reference point for the control system indicating a home position. In order to avoid using the physical stops as a home position, the two end sections 26a, 26i at the end of the rotating component range of motion are preferably kept as small as possible in order to minimize the possibility of starting out in one of the end sections 26a, 26i.

Preferably, the width of all sections 26 are set so as to maximize the difference in angle between all flags 28 and to maximize the difference in angle between all notches 32. Preferably, all flags 28 are greater than a predetermined width and all notches 32 are less than the predetermined width to further differentiate flags 28 from notches 32. In the embodiment disclosed herein, all flags 28 widths are greater than 20 degrees and all notch 32 widths are less than 20 degrees. This is done in order to minimize the possibility of confusing flag 28 versus notches 32 due to any hysteresis in the home position indicator 14. Preferably, the control system would keep track of whether the section 26 prior to the latest mark 24 was a flag 28 or a notch 32, and then that information would direct the control system to use a list of either the flag 28 widths or the notch 32 widths to compare against the previously measured section 26 width. Flags 28 measured to have a width less than 20 degrees and/or notches 32 measured to have a width greater than 20 degrees would indicate possible problems with the encoder position measurement system 10.

Preferably, the sections 26 are distributed in a manner to place the widest sections 26 next to the narrowest sections 26 in order to minimize the worst-case required movement of the rotating component 16 before the absolute position can be determined. This is done because the worst-case movement needed to determine the absolute position is slightly less than the width of any two adjacent sections 26. Two possible examples of this are shown in FIG. 5. If the machine starts at position B proximal the edge of segment 26f having a width of 36 degrees and then the machine position moves counter-clockwise, the position will have to fully traverse segment 26e having a width of 10 degrees before the absolute position is known. It should be noted that the arrows of the diagram represent how the sensor position moves relative to the target flag 18, not how the machine itself will move. Likewise if starting from Point C proximal an edge of segment 26c having a width of 18 degrees and moving clockwise, the machine must fully traverse segment 26d having a width of 30 degrees before the absolute position is known. The worst-case movement for the prior art is one half of the total movement of the machine, which in the present example is 90 degrees which is much more than for the disclosed device. Accordingly, an encoder position measurement system incorporating the present invention can provide an improved response in that a sensor malfunction can be detected when the rotating component of the work machine rotates only a little more than the maximum segment width, which is far less than in the prior art.

Another advantage of the of the encoder position measurement system 10 is the ability to cross-check the operation of the incremental encoder with respect to the sensor 42. In the prior art, one sensor transition takes place at the position defined as “Home.” Each time the home position is detected during normal operation, the position as measured by the incremental encoder can be checked to correspond to the home position. Advantageously, in the disclosed device there are multiple home positions, so the cross-checking can take place much more frequently and at many more positions of the work machine.

Advantageously, in applications where homing accuracy is highly important, it is also possible to assign one section 26 as being the most important and allowing it to override any previous position calculations. The machine can then function at reduced speeds when calibrated by all other sections 26 followed by full speed as the accuracy is maximized by crossing the most important section 26.

While there has been shown and described what is at present considered the preferred embodiment of the invention, it will be obvious to those skilled in the art that various changes and modifications can be made therein without departing from the scope of the invention defined by the following claims.

I claim:

1. A home position indicator comprising:
a target flag having a plurality of marks, pairs of adjacent marks of said plurality of marks defining sections between each adjacent pair of marks of said plurality of marks, each section having a width, wherein one of said sections having a width greater than a width of another of said sections; and
a sensor sequentially sensing two adjacent marks of said plurality of marks to determine a width of the section defined between said two adjacent marks of said plurality of marks.

2. The home position indicator as in claim 1, in which said marks are formed by a transition between target flag material presence and target flag material absence.

3. The home position sensor as in claim 1, in which said sensor is a proximity sensor.

4. The home position sensor as in claim 1, in which each section defined between a pair of adjacent marks of said plurality of marks has a width unequal to a width of every other section defined between a pair of adjacent marks of said plurality of marks.

5. The home position sensor as in claim 1, in which a first section of said sections alternates with a second section of said sections.

6. The home position sensor as in claim 5, in which said first section is a flag and said second section is a notch.

7. The home position sensor as in claim 5, in which each first section has a first width and each second section has a second width, wherein each first width is greater than each second width.

8. The home position sensor as in claim 1, in which said sections include intermediate sections between end sections, said end sections having equal widths.

9. A method of detecting a home position, said method comprising:
detecting a first mark defining a first edge of a section on a target flag having a plurality of marks defining a plurality of sections;
detecting a second mark defining a second edge of said section;
calculating a width of said section based upon a position of said first edge relative to said second edge; and
comparing said width to a list of widths, each of said widths in said list of widths corresponding to at least one section of said plurality of sections, wherein at least one of said widths of said list of widths being greater than another of said widths of said list of widths.

10. The method of detecting a home position as in claim 9, in which said marks are formed by a transition between target flag material presence and target flag material absence.

11. The method of detecting a home position as in claim 9, in which said first mark and said second mark are detected by a sensor.

12. The method of detecting a home position as in claim 9, in which each section of said plurality of sections has a width unequal to a width of every other section of said plurality of sections.

13. The method of detecting a home position as in claim 9, in which a first section of said plurality of sections alternates with a second section of said plurality of sections.

14. The method of detecting a home position as in claim 13, in which said first section is a flag and said second section is a notch.

15. The method of detecting a home position as in claim 13, in which each first section has a first width and each second section has a second width, wherein each first width is greater than each second width.

16. The method of detecting a home position as in claim 9, in which said plurality of sections include intermediate sections between end sections, said end sections having equal widths.

17. An encoder position measurement system comprising:
a home position indicator having a plurality of home positions defined by a plurality of marks; and
an incremental encoder measuring a relative position of said marks to determine an absolute position of one of said home positions.

18. The encoder position measurement system as in claim 17, in which said home position indicator includes a target flag having a plurality of marks, pairs of adjacent marks of said plurality of marks defining sections between each adjacent pair of marks of said plurality of marks, each section having a width, wherein one of said sections having a width greater than a width of another of said sections, and a sensor sequentially sensing two adjacent marks of said plurality of marks to determine a width of the section defined between said two adjacent marks of said plurality of marks.

19. The encoder position measurement system as in claim 18, in which a first section of said sections alternates with a second section of said sections.

20. The encoder position measurement system as in claim 18, in which each first section has a first width and each second section has a second width, wherein each first width is greater than each second width.
